(19) United States
(12) Patent Application Publication
(10) Pub. No.: US 2011/0260818 A1
(43) Pub. Date: Oct. 27, 2011

(54) SLIM TYPE HIGH VOLTAGE TRANSFORMER

(76) Inventors: Jongseok KIM, Seoul (KR); Haksoo LEE, Asan-si (KR); Giju HAN, Asan-si (KR); Miae YUN, Chuncheon-si (KR)

(21) Appl. No.: 12/912,043

(22) Filed: Oct. 26, 2010

(30) Foreign Application Priority Data
Apr. 23, 2010 (KR) 10-2010-0037697

(51) Int. Cl. H01F 27/02; H01F 5/02

(52) U.S. Cl. 336/92

(57) ABSTRACT

A slim-type high voltage transformer includes a case, and a plurality of transformer portions configured by mounting a plurality of primary and secondary winding coils to protruding grooves formed in the interior of the case and then mounting a first copperplate core on the primary and secondary winding coils. In the transformer, the plurality of transformer portions are disposed bilaterally symmetric, and share at least one copperplate core and an insulating member interposed between the primary and secondary winding coils and the copperplate core. Accordingly, a bobbin for winding a coil is not used, so that the height of the transformer can be minimized, thereby decreasing the size of products. Also, a winding is molded, so that the insulation and heat generation of the winding can be effectively controlled, thereby improving the stability of the transformer.

### CROSS REFERENCE

This application claims foreign priority under Paris Convention and 35 U.S.C. §119 to Korean Patent Application No. 10-2010-0037697, filed Apr. 23, 2010 with the Korean Intellectual Property Office.

### BACKGROUND OF THE INVENTION

1. Technical Field

An aspect of the present invention relates to a high voltage transformer, and more particularly, to a slim-type high voltage transformer in which a plurality of protruding grooves in place of a bobbin are formed in the interior of a case, and primary and secondary winding coils are mounted to the protruding grooves, thereby minimizing the height of the transformer.

2. Description of the Related Art

Recently, liquid crystal displays (LCDs) have been widely used not only for personal computers and notebook computers but also for office automation equipments such as photocopiers and portable devices such as cellular phones and beepers because they can be miniaturized as compared with cathode ray tubes (CRTs).

Since an LCD is not a self-luminescent display device, it requires a light source such as a backlight. The backlight is driven by an inverter, and consumes the most amount of power in the LCD.

Meanwhile, the inverter has a high voltage transformer to drive the backlight. The transformer functions to apply voltage to a lamp that constitutes an LCD panel by generating high AC output voltage with low AC input voltage.

The transformer resonates with the capacitance of the lamp and panel at the frequency applied to a primary side thereof, so that secondary voltage can be more increased than the turn ratio of primary and secondary windings. Therefore, the transformer may be referred to as a resonant transformer.

The transformer is generally manufactured by winding a primary coil at the low voltage side and a secondary coil at the high voltage side around a bobbin having a core inserted into a hollow portion thereof. One coil referred to as the primary coil is connected to an input circuit in which voltage is to be changed, and the other coil referred to as the secondary coil is connected to an output circuit in which the changed (transformed) voltage is used. When AC current of the input circuit passes through the primary coil, a magnetic field of which intensity and direction are changed is generated in response to the AC current. The change of magnetic flux induces AC voltage in the secondary coil, and the turn ratio of the primary and secondary coils determines a voltage transformation ratio.

A conventional transformer includes one bobbin having first and second coil winding portions around which primary and secondary coils are wound, respectively, a transformer cap into which the bobbin is inserted, and a pair of [symbol] shaped cores respectively inserted into insertion holes formed in the bobbin by passing through both side portions of the transformer cap.

In the case of such a small-sized high voltage transformer, the winding turns of a coil at the high voltage side are considerably greater than those of a coil at the low voltage side, and hence the current that flows in the coil at the high voltage side is much less than the current that flows in the coil at the low voltage side. Therefore, the thickness of the coil at the high voltage side is much thinner than that of the coil at the low voltage side.

However, since the conventional transformer described above is used by winding the primary and secondary coils around only one bobbin, the primary and secondary coils are necessarily spaced apart from each other at a certain spacing distance so as to secure a creepage distance necessary for insulation, and therefore, the winding area of the primary coil is partially wasted. Further, since the bobbin is used to allow the primary and secondary coils to be wound therearound, there is a limitation in decreasing the height of the bobbin. Therefore, there is a limitation in slimming the transformer.

### SUMMARY OF THE INVENTION

Embodiments provide a slim-type high voltage transformer in which at least one isolating partition wall in place of a bobbin is formed in the interior of a case, and primary and secondary winding coils are mounted to protruding grooves, thereby minimizing the height of the transformer.

In embodiment, there is provided a slim-type high voltage transformer including: a case; and a plurality of transformer portions configured by mounting a plurality of primary and secondary winding coils to protruding grooves formed in the interior of the case and then mounting a first copperplate core on the primary and secondary winding coils, wherein the plurality of transformer portions are disposed bilaterally symmetric, and share at least one copperplate core and an insulating member interposed between the primary and secondary winding coils and the copperplate core.

### BRIEF DESCRIPTION OF THE DRAWINGS

The above and other aspects, features and advantages disclosed herein will become apparent from the following description of preferred embodiments given in conjunction with the accompanying drawings, in which:

FIG. 1 is an exploded perspective view briefly showing the configuration of a slim-type high voltage transformer according to a first embodiment of the present invention;

FIG. 2 is a bottom view of a case of the slim-type high voltage transformer according to the first embodiment of the present invention;

FIG. 3 is an exploded perspective view briefly showing the configuration of a slim-type high voltage transformer according to a second embodiment of the present invention;

FIG. 4 is an exploded perspective view briefly showing the configuration of a slim-type high voltage transformer according to a third embodiment of the present invention;

FIG. 5 is an exploded perspective view briefly showing the configuration of a slim-type high voltage transformer according to a fourth embodiment of the present invention;

### DESCRIPTION OF SPECIFIC EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments. In the drawings, like reference numerals in the drawings denote like elements, and their overlapping descriptions will be omitted. The shape, size and regions, and the like, of the drawing may be exaggerated for clarity.

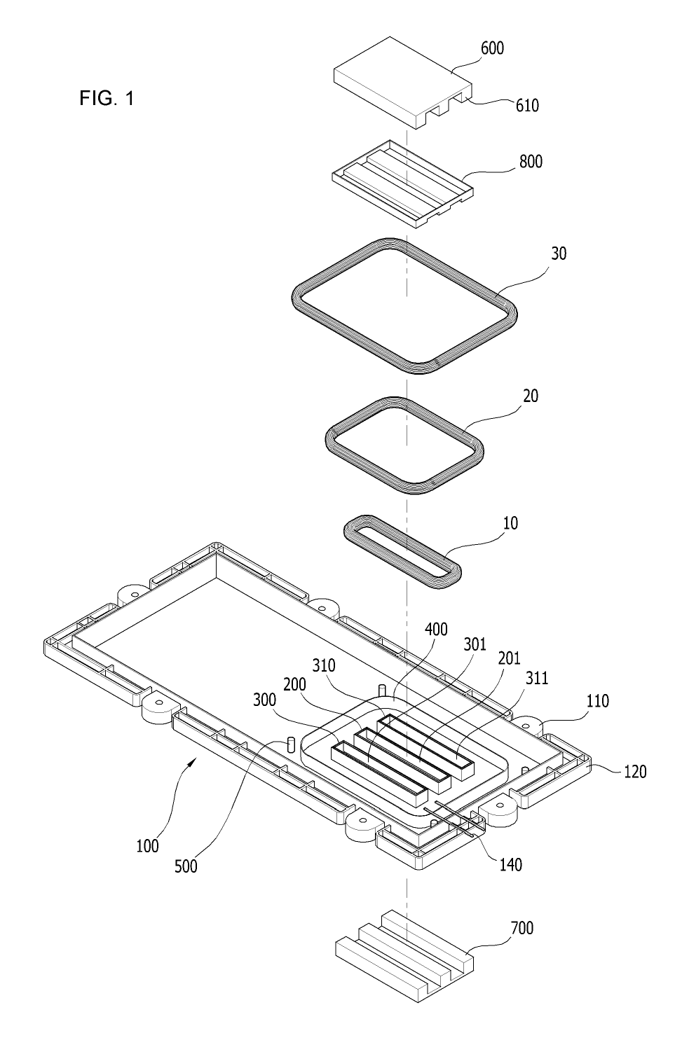

FIG. 1 is an exploded perspective view briefly showing the configuration of a slim-type high voltage transformer according to a first embodiment of the present invention.

The slim-type high voltage transformer according to the first embodiment of the present invention includes a case 100 and a transformer portion. The transformer portion includes a first protruding groove 200, second and third protruding grooves 300 and 310, an isolating partition wall 400, fixing projections 500, first and second copperplate cores 600 and 700, and an insulating member 800.

The case 100 is a plastic injection molded product. At least one semicircular projection 110 to be fixed by a bolt is formed at each side of the case 100, and a [symbol] shaped outer wall 120 is formed at each corner of the case 100, considering the thermal resistance and tensile strength of the product in molding. The interior of the case 100, in which components are mounted, is molded with a molding material including an epoxy or urethane resin to which a thermal resistant resin is added.

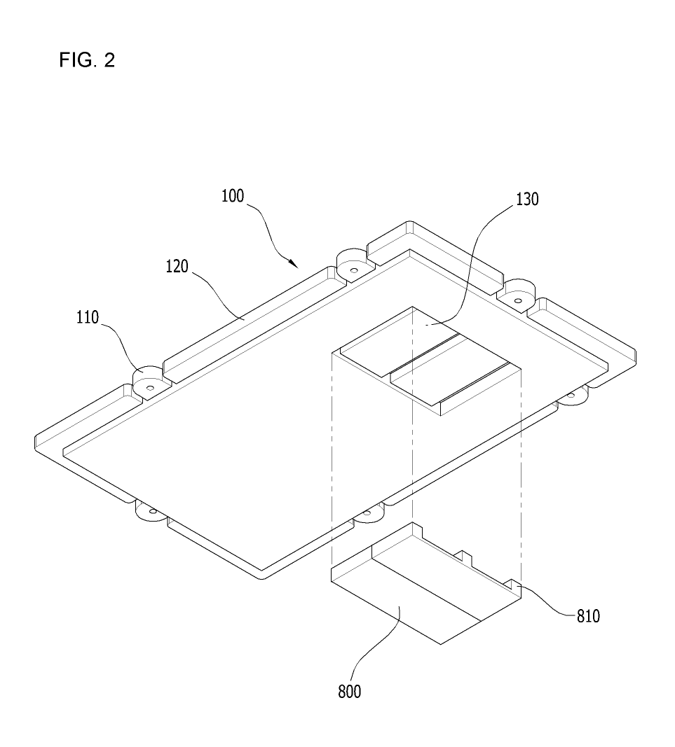

As shown in FIG. 2, the case 100 has an accommodating groove 130 formed at a bottom surface thereof. Here, the accommodating groove 130 accommodates the second copperplate core 700 that constitutes a pair with the first copperplate core 600.

The first protruding groove 200 is formed to mount a primary winding coil 10 wound in the shape of a rectangular or elliptic track in the interior of the case 100.

The second and third protruding grooves 300 and 310 are respectively formed at left and right sides about the first protruding groove 200 for the purpose of insulation between a plurality of secondary winding coils 20 and 30 mounted thereto and the primary winding coil 10. In this instance, the mounted primary and secondary winding coils 10, 20 and 30 are wound so that their diameters are increased in the order of the primary winding coil 10<the secondary winding coil 20<the secondary winding coil 30.

The isolating partition wall 400 is formed between the secondary winding coils 20 and 30 for the purpose of insulation between the mounted secondary winding coils 20 and 30.

The plurality of fixing projections 500 are formed so that the secondary winding coil 30 is adhered and fixed to the isolating partition wall 400.

The first and second copperplate cores 600 and 700 are “E” shaped cores. The first and second copperplate cores 600 and 700 are used to make the shape of a magnetic field according to magnetic induction, and a closed circuit is formed about an intermediate core. In this instance, the loss due to eddy current is prevented by using a plurality of copperplate cores.

The insulating member 800 is interposed between the first protruding groove 200 and the first copperplate core 600 to insulate the primary and secondary winding coils 10, 20 and 30 from the first copperplate core 600.

The first and second protruding grooves 200, 300 and 310 are provided with through-holes 201, 301 and 311 respectively coupled to convex grooves 610 formed on the bottom surface of the first copperplate core 600. The insulating member 800 is provided with a plurality of through-holes (not shown) so that the convex grooves 610 of the first copperplate core 600 are coupled to the through-holes 201, 301 and 311, respectively.

In this instance, the through-holes 201, 301 and 311 are formed so that their halls are extended to the accommodating groove 130 at a bottom surface of the case 100.

Meanwhile, the case 100 further includes a conducting member 140 attached to one side of the case 100 or the primary winding coil 10. The conducting member 140 is electrically connected to a wire (not shown) extended to the primary winding coil 10 from the exterior thereof. The conducting member 140 and the primary winding coil 10 are wire-bonded to each other.

The secondary winding coils 20 and 30 are wire-bonded to a voltage distribution portion (not shown) mounted at a specific position in the case 100. Here, the voltage distribution portion functions to rectify AC boosted in the transformer portion to DC and to output high voltage.

Hereinafter, a manufacturing process of the slim-type high voltage transformer according to the first embodiment of the present invention will be described with the drawings.

As shown in FIG. 1, the first protruding groove 200, the second protruding grooves 300 and 310 and the isolating partition wall 400 and fixing projections 500 are previously formed in the interior of the case 100.

Subsequently, the primary winding coil 10 wound in the shape of the rectangular or elliptic track is mounted to the first protruding groove 200, and the second winding coil 20 having the same shape as but a greater diameter than the primary winding coil 10 is mounted between the second and third protruding grooves 300 and 310 and the isolating partition wall 400 previously formed at the exterior of the second and third protruding grooves 300 and 310. Then, the secondary winding coil 30 having the same shape as but a greater diameter than the secondary winding coil 20 is mounted between the isolating partition wall 400 and the fixing projections 500. In this instance, the primary and second winding coils 10, 20 and 30 are not dispersed but maintain their wound shape even after they are wound in the shape of the rectangular or elliptic track.

If the mounting of the primary and secondary winding coils 10, 20 and 30 is completed, the insulating member 800 is coupled to the first, second and third protruding grooves 200, 300 and 310, and the first copperplate core 600 is mounted on the insulating member 800 to be coupled to the insulating member 800. In this instance, the plurality of through-holes are formed in the insulating member 800 so that the convex grooves 610 of the first copperplate core 600 are coupled to the through-holes 201, 301 and 311 of the first, second and third protruding grooves 200, 300 and 310, respectively.

The second copperplate core 700 is accommodated in the accommodating groove 130 to be connected to the first copperplate core 600 through the through-holes 201, 301 and 311 of the first, second and third protruding grooves 200, 300 and 310.

Subsequently, the primary winding coil 10 is wire-bonded to the conducting member 140 to be connected to an external wire, and the secondary winding coils 20 and 30 are wire-bonded to the voltage distribution portion mounted at the specific position in the case 100.

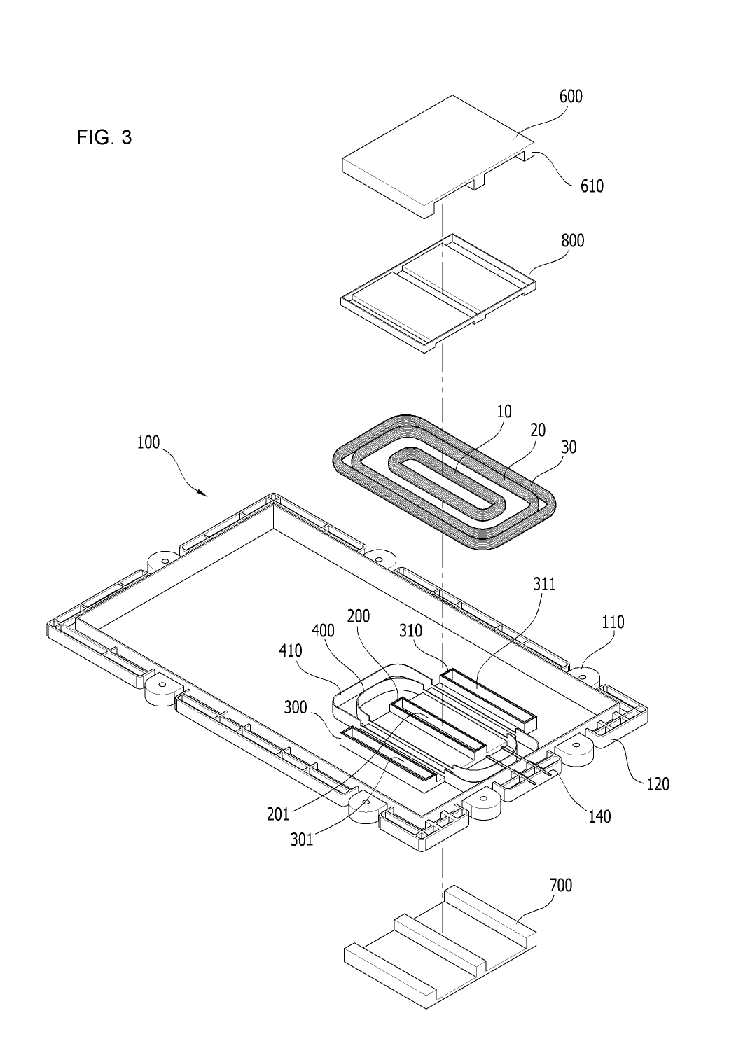

FIG. 3 is an exploded perspective view briefly showing the configuration of a slim-type high voltage transformer according to a second embodiment of the present invention.

As shown in FIG. 3, the slim-type high voltage transformer according to the second embodiment of the present invention is provided with a case 100 and a transformer portion. The transformer portion includes a first protruding groove 200, a second protruding grooves 300 and 310, a first isolating partition wall 400, a second isolating partition wall 410, first and second copperplate cores 600 and 700 and an insulating member 800.

The first protruding groove 200 is formed to mount a primary winding coil 10 wound in the shape of a rectangular or elliptic track in the interior of the case 100.

The first isolating partition wall 400 is formed to insulate secondary winding coils 20 and 30 mounted at an outer circumference of the primary winding coil 10 from the primary winding coil 10.

The second isolating partition wall 410 is formed between the secondary winding coils 20 and 30 for the purposed of insulation between the secondary winding coils 20 and 30.

The second and third protruding grooves 300 and 310 are formed so that the secondary winding coil 30 is adhered and fixed to the second isolating partition wall 410.

The insulating member 800 is interposed between the first, second and third protruding grooves 200, 300 and 310 and the first copperplate core 600 to insulate the primary and secondary winding coils 10, 20 and 30 from the first copperplate core 600.

The first protruding groove 200 and the second and third protruding grooves 300 and 310 are provided with through-holes 201, 301 and 311 respectively coupled to convex grooves 610 formed on the bottom surface of the first copperplate core 600. The insulating member 800 is provided with a plurality of through-holes (not shown) so that the convex grooves 610 of the first copperplate core 600 are coupled to the through-holes 201, 301 and 311, respectively.

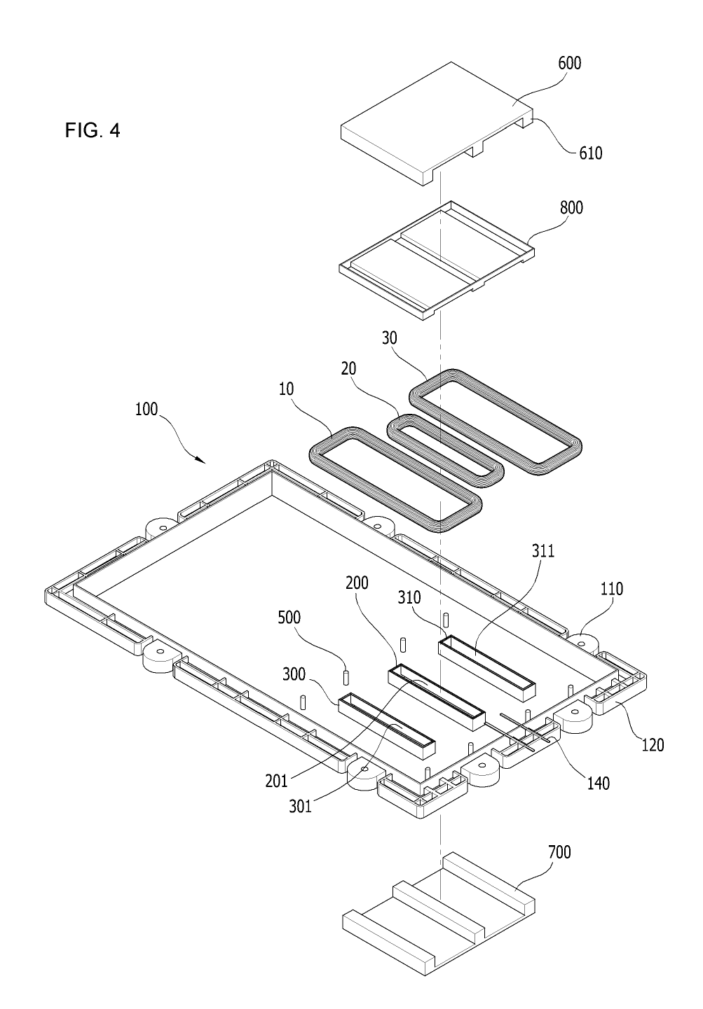

FIG. 4 is an exploded perspective view briefly showing the configuration of a slim-type high voltage transformer according to a third embodiment of the present invention.

The slim-type high voltage transformer according to the third embodiment of the present invention is provided with a case 100 and a transformer portion. The transformer portion includes first, second and third protruding grooves 200, 300 and 310, fixing projections 500, first and second copperplate cores 600 and 700 and an insulating member 800.

The first protruding groove 200 is formed to mount a primary winding coil 10 in the interior of the case 100.

The second and third protruding grooves 300 and 310 are formed at left and right sides about the first protruding groove 200 while being spaced from the first protruding groove 200 at a certain distance so as to mount secondary winding coils 20 and 30 thereto, respectively.

The plurality of fixing projections 500 are formed to fix and insulate the primary and secondary winding coils 10, 20 and 300 respectively mounted to the first, second and third protruding grooves 200, 300 and 310.

The insulating layer 800 is interposed between the first, second and third protruding grooves 200, 300 and 310 and the first copperplate core 600 to insulate the primary and secondary winding coils 10, 20 and 30 from the first copperplate core 600.

The first, second and third protruding grooves 200, 300 and 310 are provided with through-holes 201, 301 and 311 respectively coupled to convex grooves 610 formed on the bottom surface of the first copperplate core 600.

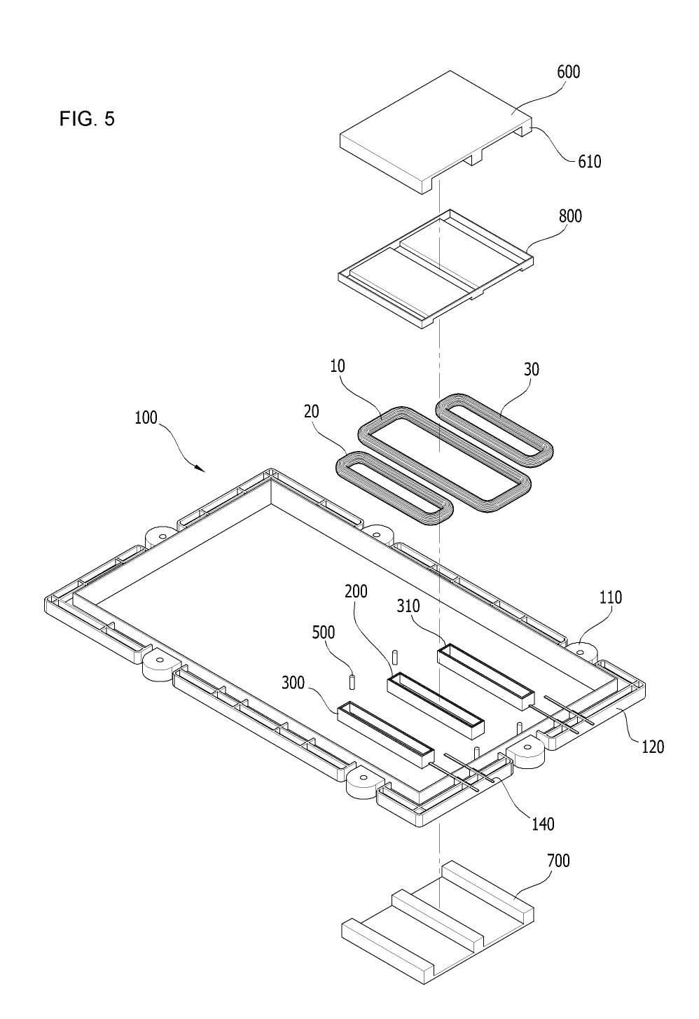

FIG. 5 is an exploded perspective view briefly showing the configuration of a slim-type high voltage transformer according to a fourth embodiment of the present invention.

As shown in FIG. 5, the slim-type high voltage transformer according to the fourth embodiment of the present invention has the same configuration as that according to the third embodiment of the present invention. However, the slim-type high voltage transformer according to the fourth embodiment of the present invention is different from that according to the third embodiment of the present invention in that a secondary winding coil is mounted to the first protruding groove 200 and primary winding coils 10 are mounted to the second and third protruding grooves 300 and 310, respectively.

Meanwhile, in the first, second, third and fourth embodiments, if the mounting of all the components is finished, the interior of the case 100 is molded with a molding material including an epoxy or urethane resin to which a thermal resistant resin is added, and the case 100 is then covered by a cover (not shown), thereby sealing the case 100.

While the disclosure has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A slim-type high voltage transformer comprising:
a case; and
a transformer portion configured by mounting at least primary and secondary winding coils wound in the shape of a rectangular or elliptic track to protruding grooves formed in the interior of the case and then mounting a first copperplate core on the primary and secondary winding coils, wherein the transformer portion further comprises an insulating member interposed between the primary and secondary winding coils and the first copperplate core.

2. The transformer according to claim 1, wherein the transformer portion is configured by mounting a primary winding coil wound in the shape of a rectangular or elliptic track in the interior of the case, mounting one secondary winding coil having the same shape as but a greater diameter than the primary winding coil at an outer circumference of the primary winding coil and then mounting another secondary winding coil having the same shape as but a greater diameter than the one secondary winding coil at an outer circumference of the one secondary winding coil.

3. The transformer according to claim 1, wherein the transformer portion is configured by mounting a primary winding coil wound in the shape of a rectangular or elliptic track in the interior of the case and then mounting secondary winding coils having the same shape at left and right sides about the primary winding coil while being spaced apart from the primary winding coil at a certain distance, respectively.

4. The transformer according to claim 1, wherein the transformer portion is configured by mounting a secondary winding coil wound in the shape of a rectangular or elliptic track in the interior of the case and then mounting primary winding coils having the same shape at left and right sides about the secondary winding coil while being spaced apart from the secondary winding coil at a certain distance, respectively.

5. The transformer according to claim 1, wherein the transformer portion comprises:
a first protruding groove formed in the interior of the case to mount a primary winding coil wound in the shape of a rectangular or elliptic track;
second and third protruding grooves respectively formed at left and right sides about the first protruding groove for the purpose of insulation between a plurality of secondary winding coils mounted thereto and the primary winding coil;
an isolating partition wall formed between for the purpose of insulation between the plurality of secondary winding coils; and
a plurality of fixing projections formed so that the secondary winding coil is adhered and fixed to the isolating partition wall, wherein the first, second and third protruding grooves are provided with first through-holes respectively coupled to convex grooves formed on the bottom surface of the first copperplate core.

6. The transformer according to claim 1, wherein the transformer portion comprises:
a first protruding groove formed in the interior of the case to mount a primary winding coil wound in the shape of a rectangular or elliptic track;
a first isolating partition wall formed to insulate a plurality of secondary winding coils mounted at an outer circumference of the primary winding coil from the primary winding coil;
a second isolating partition wall formed between the plurality of secondary winding coils for the purpose of insulation between the plurality of secondary winding coils; and
second and third protruding grooves formed so that the secondary winding coil is adhered and fixed to the second isolating partition wall,
wherein the first, second and third protruding grooves are provided with first through-holes respectively coupled to convex grooves formed on the bottom surface of the first copperplate core.

7. The transformer according to claim 1, wherein the transformer portion comprises:
a first protruding groove formed in the interior of the case to mount a primary winding coil;
second and third protruding grooves respectively formed to mount secondary winding coils at left and right sides about the first protruding groove; and
a plurality of fixing projections formed to fix and insulate the primary and secondary winding coils respectively mounted to the first, second and third protruding grooves, wherein the first, second and third protruding grooves are provided with first through-holes respectively coupled to convex grooves formed on the bottom surface of the first copperplate core.

8. The transformer according to claim 1, wherein the transformer portion comprises:
a first protruding groove formed in the interior of the case to mount a secondary winding coil;
second and third protruding grooves respectively formed to mount primary winding coils at left and right sides about the first protruding groove; and
a plurality of fixing projections formed to fix and insulate the secondary and primary winding coils respectively mounted to the first, second and third protruding grooves, wherein the first, second and third protruding grooves are provided with first through-holes respectively coupled to convex grooves formed on the bottom surface of the first copperplate core.

9. The transformer according to claim 1, wherein the insulating member is provided with a plurality of second through-holes formed so that the concave grooves of the first copperplate core are coupled to the first through-holes, respectively.

10. The transformer according to claim 1, wherein the interior of the case, in which components are mounted, is molded with a molding material including an epoxy or urethane resin to which a thermal resistant resin is added.

11. The transformer according to claim 1, wherein the case is a plastic injection molded product and further comprises a conducting member attached to a side of the primary winding coil, and the conducting member is electrically connected to a wire extended to the primary winding coil from the exterior of the case.

12. The transformer according to claim 1, wherein the case is provided with at least one semicircular projection to be fixed by a bolt is formed at each side of the case, and a [symbol] shaped outer wall is formed at each corner of the case, considering the thermal resistance and tensile strength of the product in molding.
